(19) United States
(12) Patent Application Publication
(10) Pub. No.: US 2019/0073896 A1
(43) Pub. Date: Mar. 7, 2019

(54) MASS NOTIFICATION AND VENUE SECURITY SYSTEM AND METHOD

(71) Applicant: Guardian Zone, LLC, Colleyville, TX (US)

(72) Inventors: Sheryl Pinckney-Maas, Colleyville, TX (US); Hein Maas, Colleyville, TX (US)

(73) Assignee: Guardian Zone, LLC

(21) Appl. No.: 16/021,757

(22) Filed: Jun. 28, 2018

Related U.S. Application Data
(60) Provisional application No. 62/526,676, filed on Jun. 29, 2017.

(51) Int. Cl. G08B 27/00; H04M 1/725; H04W 4/021; H04W 4/90; H04W 4/08

(52) U.S. Cl. CPC G08B 27/006; H04M 1/72536; H04W 4/08; H04W 4/90; H04W 4/021

(57) ABSTRACT

A system, method, and non-transitory computer readable medium including executable instructions, for mass notifications and venue security may include a cloud-based mass notification and venue security system server, a communications network, a venue perimeter identifier associated with a physical venue, an event status identifier associated with a time-bounded event at the venue, a plurality of personal wireless devices each having an installed application configured to be identified in relation to the server for communications, and the server and application configured to use the venue perimeter identifier and event status identified to provide one-way mass notification communications and two-way venue security communications between the server and each personal wireless device identified at the venue by the venue perimeter identifier during a time period of an event at the same venue, as indicated by the event status identifier.

### CROSS-REFERENCE TO RELATED APPLICATIONS

This application is related and claims priority to U.S. Provisional Application No. 62/526,676 filed Jun. 29, 2017 and titled “MASS NOTIFICATION AND VENUE SECURITY SYSTEM AND METHOD”, the entire contents of same being incorporated by reference. This application is related to U.S. Provisional Application No. 62/332,694 filed May 6, 2016 and titled “MASS NOTIFICATION AND VENUE SECURITY SYSTEM AND METHOD”, the entire contents of same being incorporated by reference.

### BACKGROUND OF THE INVENTION

Current mass notification systems, which includes mass alert technology, are limited in usage and functions in important ways. Current venue, facility and site security systems also are limited both in usefulness and functionality. Current personal security software applications for personal mobile devices such as smartphones are incompatible with each other and limited in number of users, utility and functionality. Need exists for improved mass notification systems, venue security systems, and personal security software applications for personal mobile devices such as smartphones and other wireless computing devices such as tablets and smart watches.

### BRIEF SUMMARY OF THE INVENTION

In this disclosure the terms “mass notification” or “notifications” include, without limitation, mass alerts or alerts. In this disclosure, “venues” or “venue” includes, without limitation, facilities, sites and buildings of a designated venue. “As used herein, open community” means communities or communications networks which are open for being joined by users, secure in having security features intended to prevent unauthorized usage by unauthorized users and unauthorized communications by any users, accessible to authorized users at a venue, and temporary in being organized for time-limited operation. Current mass notification systems may be very limited in being closed systems that require each individual user to preregister in order to use the system as part of a pre-established community (e.g. employees of the company, students/faculty of a university, etc.) and only thereafter receive notifications in the case of an emergency. Temporary and casual visitors to a locale such as a venue, university, campus, or district typically are not pre-registered and thus are not accommodated to make use of such systems. Typically, mass notifications sent to individual users are limited to SMS text messages. Mass notification systems typically are limited to one-way communication with individual users, in that such systems do not typically receive alerts from individual users and operate as if the individuals, who may be located at the scene or in the immediate vicinity of an emergency event, are merely subscribers who need to receive mass notification messages but are not themselves viable sources of intelligence or information, or immediate providers of assistance such as, for example, medical care, directions, protection, security, or immediate safety communications to others in the same area.

Downloadable personal security software applications for general use by individuals on their personal smartphones typically do not communicate with mass notification systems that serve a local area or venue. Personal security software applications for smartphones may not have capability to identify or enter into direct or indirect communication with an existing mass notification system, to serve as a mass notification receiver. Personal security software applications also may not have capability to communicate with a closed venue security system for any purpose, for receiving mass notifications, or for sending and receiving alerts, original incident reports, or communications over such a system. Personal security software applications may not have capability to communicate with a venue security system for sending or receiving communications such as alerts, original incident reports or communications on the venue security system. Venue security systems typically are limited in receiving information from the limited group of venue security personnel and paramedics paid to provide security services for an event or venue and communicating over private channels, such as radio channels, and information from the fixed, preinstalled network of venue security cameras and sensors such as pre-wired door alarm sensors and fire alarms that typically exist is such large venues. These major limitations leave all unregistered individuals and essentially everyone other than the limited group of venue managers and professional security system personnel who work for the venue, or who work for the security service providing security or medical services for a particular event, and leaves customers, guests and particularly casual visitors out of communication with major venue security system information resources such as venue security personnel, venue security systems, and other visitors located in the same venue but outside of speaking range when emergencies occur. These limitations expose visitors and security personnel to unnecessary risks. These limitations also increase cost for venues to provide security for visitors.

Disclosed subject matter provides systems and methods for providing mass notification and venue security that are open and may not require each individual user to pre-register in order to download and use a smartphone software application for communication with a mass notification and venue security system to receive notifications in the case of an emergency. Disclosed subject matter also provides systems and methods for providing mass notification and venue security that may be open and may enable individual users to download and use a smartphone software application for communication with a mass notification and venue security system to receive notifications in the case of an emergency, where the smartphone software application may be automatically connected in communication with the mass notification and venue security system upon being downloaded to the smartphone. Disclosed subject matter provides such systems and methods that may enable sending mass notifications, and for receiving and displaying mass notifications on a smartphone software application on the smartphone of each individual, that are not limited to SMS text messages. For example, mass notification messages may be received and displayed that may include visual images such as photos or video clips, maps directing users to safe or protected locations, and audio clips such as instructions or alarm sounds. Disclosed subject matter provides such systems and methods where a personal security software application on a smartphone of each individual, or many individuals, in a local area or venue may connect to an existing mass notification system, to serve as a mass notification receiver for each individual. Disclosed subject matter provides such systems and methods where a personal security software application on a smartphone of an individual has capability to communicate with a venue security system for receiving mass notifications. Disclosed subject matter provides such systems and methods where a personal security software application on a smartphone of an individual has capability to communicate with a venue security system for sending alerts on the venue security system, such as alerts to venue security personnel. Disclosed subject matter provides such systems and methods where a venue security system may be open and thus is not limited to receiving information from the limited group of venue security personnel and paramedics paid to provide security services for an event or venue and communicating over private radio channels, and from the fixed, preinstalled network of venue security cameras and sensors such as pre-wired door alarm sensors and fire alarms. Disclosed subject matter provides such systems and methods where a venue security system may be open and may include capability for communications with a large number of personal security software applications installed on the smartphones of many unfamiliar individuals, such as casual visitors, using a venue. Disclosed subject matter provides such systems and methods where a venue security system may be open and enable sending and receiving of alerts, information, information requests, and mass notification via SMS text messages and other message protocols that may include audio, video, and other non-SMS data formats, both to and from individuals, such as casual visitors to a venue. Disclosed subject matter provides such systems and methods where a venue security system may include alert communications, individual communications, and mass notifications both to and from individuals such as casual visitors for coordinating and leveraging the immediate knowledge and face to face communications between ordinary visitors and venue security personnel out of immediate speaking range with each other individuals located in the same venue when emergencies occur. Disclosed subject matter provides such systems and methods where a mass notification and venue security system reduce exposure to risk, threats and harm to visitors and security personnel. Disclosed subject matter provides such systems and methods where a mass notification and venue security system of high efficiency and effectiveness in terms of immediate information sources and communication or dissemination of timely communications and making information available to multiple system roles and users for effective management of an emergency event with reduced cost for fixed infrastructure and improved, participatory security for visitors to the venue.

Disclosed subject matter provides systems and methods for venue security including mass notifications, including capability for immediate communications between all or many unfamiliar individuals in a venue, such as in a venue perimeter determined by a geofence, by personal smartphones each having a downloadable smartphone software application installed thereupon and operable for communications with either a venue security system, a mass notification system, a venue security system having mass notifications functionality, a mass notification system having venue security system functionality, or any combination of the preceding systems. Disclosed subject matter provides such systems and methods for venue security including mass notifications provided from a cloud-based server resource and accessible via such a smartphone software application and/or portal, such as, for example, a local or remote system portal accessible by a browser or on a local software application by security system administrators and related professional security system personnel registered to use the system in various roles and with various access authorizations and restrictions. Disclosed subject matter provides such systems and methods for venue security including mass notifications, and configured for communications with a large number of identical or compatible downloadable software applications installed on personal smartphones of casual visitors, without requiring pre-registration by the individuals. It will be understood that such systems and methods provide and include an expanded venue security network including a large number of temporary security information resources for collecting information input or collected by individuals distributed about the venue in their personal use of the venue, and for sending and receiving alerts and mass notifications, which are provided by the large number of personal smartphones each having the identical or compatible downloaded software application and individuals using the same, where the personal smartphones are temporarily in communication with the venue security system and mass notification system only while each individual is present at the venue. It will be understood that having such an expanded venue security network enables increased information sources and information collection, and increased dissemination of communications among many individuals for security in the venue, which may improve detection, identification and tracking of security threats and medical emergencies, and improves speed of the responses of professional venue security personnel to such emergency events, with reduced risk, threat and harm to individuals and security personnel without incurring the high cost of expanding installation of permanent, fixed infrastructure that might provide similar capability and functions, and which is rendered unnecessary.

Embodiments of the present disclosure may transmit security mass notification alerts across multiple platforms, including cellular network to personal mobile devices, e.g. smartphones (e.g. Androids, iPhones and other cellular technologies), which may be located within a geo-fenced designated area. In some embodiments, alerts may be sent during periods of potential danger, perceived danger, or imminent danger or events.

Existing technology is limited in that it typically, when available, requires that a user, or user's mobile device, be associated with a specific software application for a limited community. The present disclosure improves on existing technology by allowing a single sign on event for users, which can then interact with security networks whenever available.

In some embodiments, a notification may be transmitted to a software application on a personal mobile device to provide notification that the user is within a protected perimeter and that they are now connected to security. The software application user is automatically added to the open mass notification and venue security system client dashboard when they enter the secured perimeter allowing for interaction.

By the software application on each personal mobile device, individuals may use the mass notification and security system to send and receive messages to and from the venue security system and venue security personnel while in a designated protected area or perimeter corresponding to or designated as the venue. Capability of the software application to enable direct interaction by the individual enables immediate and detailed communications with venue security personnel and the venue security system during an emergency.

In the designated perimeter of a protected zone associated with the mass notification and venue security system, personal mobile devices including the software application enable and perform functions of a handheld mobile security device for each individual having such a personal mobile device including the software application, and further may provide security services and information for members of the public in immediate proximity of such individuals using and participating in providing the expanded network system.

The software application, the smartphone and the software application users all become an extension of security adding additional eyes and ears to venue safety.

Software application users are able to send “emergency alerts” that are preprogrammed messages to security as well as original incident reports while in the designated area, and therefore are able to get immediate assistance. The software application cuts down on the time needed to contact security.

When an emergency alert is sent, it is received by the venue's mass notification and venue security system, and displayed and managed via a venue client portal including a venue client dashboard. The venue client dashboard displays the information and enables the venue security administrator or other personnel using the dashboard to be informed of the emergency and take actions according to the venue's security protocols.

When an emergency alert is sent, it is logged into the administration portal. The portal enables the mass notification and venue security system administrator to keep track of reported emergencies from all supported venues. An interface may display or provide a single administration portal having an administration dashboard that may enable administrative monitoring of multiple venues in multiple locations in different geographical areas including, for example, cities, states or countries. The alert logs may provide backup data for the venue's client dashboard and can be used for further investigation.

The software application includes the capability within the software application to send photos to security to support any alerts or incident reports. This enables, for example, venue security to use the information during event response, follow up or investigation.

Disclosed subject matter includes systems and methods that identify and solve problems previously unrecognized or unknown to those of skill in the art and solve problems including the providing of timely and specific information for improving safety, well-being and security of individuals, including regular visitors, transient visitors, and casual visitors, moving in and out of large public spaces that may be defined as one or more protected zones each having a respective perimeter, such that individuals may be connected in communication with venue security systems having mass notification functionality, and security personnel via the same, at all times when entering, and throughout, each such defined venue.

A plurality of the mass notification and venue security systems may provide or form a network of protected venues that are connected by the software applications associated with personal mobile devices of individuals.

The mass notification and venue security system software application can be used by an individual having the personal mobile device in any venue having an identical or compatible protected zone mass notification and venue security system. Each venue may separately maintain and operate their individual closed, preexisting security systems. The overall network of all protected zone mass notification and venue security systems for a plurality of venues may thus create and provide multiple locations where all individuals having the protected zone software application installed on a personal mobile device.

The protected zone mass notification and venue security system thus creates an environment of locations of venues where individuals may utilize the protected zone downloaded software application to actively participate in providing security information for each venue and protect themselves and others.

When an alert is sent to venue security, multiple designated contacts designated by each individual using the protected zone software application user will receive an SMS alert. These alerts will enable the contacts to be informed of the emergency.

The software application allows users to indicate whether they are first responders or have other designated skills for providing medical care, emergency logistics management, security, response capabilities and communications.

A system that combines cloud-based localized mass notification security software with personal security functionality. The software is uniquely designed to interface with the mobile software application installed on all Android, iPhone, and other similar cellular phone technologies. The software application is an interactive software application that has preprogrammed alerts and the capability to send original incident reports via SMS to venue security and include a supporting picture. This allows the software application user by virtue of having and using the software application to become a viable extension of a venue security network and the smartphone to become a handheld security device. Security can send mass notification alerts to all software application users in its designated area for security and safety matters. The system may use GPS, IPS and WiFi functionality, or any other suitable location technology, to inform venue security of the location of the software application user when emergency alerts and incident reports are received. GPS functionality is used to define the designated perimeters for venues and allow software application users to be informed about the location of protected venues or areas. Communication can be initiated from either the software application user or venue.

All smartphones having identical or compatible downloadable software applications installed thereupon can function in all venues where any communications infrastructure, such as a local WIFI, LAN, WAN, cellular, or other mobile communications network can provide a communications link, whether direct or indirectly routed across suitable communications infrastructure or communications resources in any manner, with a compatible protected zone server resource, such as a cloud-based server, or with other smartphones having the identical or compatible downloadable software applications installed thereupon. Such a networked plurality of smartphone applications and server resources may provide a communications network infrastructure for communication across all locations and venues where any protected zone system is operable, and thus may provide a globally interconnected safety network for individuals, venues and professional security and safety personnel having the downloaded software application on smartphones in their possession or having access to a protected zone system portal such as from a browser. Individuals having the software application on their personal smartphone, when not in a designated protected zone perimeter, also can utilized basic personal security functions of the software application such as, for example, sending pre-programmed SMS text messages to multiple designated contacts or recipients in relation to potential or imminent danger, or to request assistance in a personal emergency, along with information regarding the location and related information about the personal smartphone and individual user.

### BRIEF DESCRIPTION OF THE DRAWINGS

The novel features believed characteristic of the disclosed subject matter will be set forth in any claims that are filed later. The disclosed subject matter itself, however, as well as a preferred mode of use, further objectives, and advantages thereof, will best be understood by reference to the following detailed description of an illustrative embodiment when read in conjunction with the accompanying drawings, wherein:

FIG. 1A is a simplified diagram illustrating aspects of a mass notification and venue security system in an embodiment.

FIG. 1B is a simplified diagram illustrating aspects of a mass notification and venue security system in an embodiment.

FIG. 2 is a simplified diagram illustrating aspects of a mass notification and venue security system in an embodiment.

FIG. 3A is a simplified diagram illustrating aspects of a mass notification and venue security system in an embodiment.

FIG. 3B is a simplified diagram illustrating aspects of a mass notification and venue security system in an embodiment.

FIG. 4 is a simplified diagram illustrating aspects of a mass notification and venue security system in an embodiment.

FIG. 5 is a simplified diagram illustrating aspects of a mass notification and venue security system in an embodiment.

FIG. 6A is a simplified diagram illustrating aspects of a mass notification and venue security system in an embodiment.

FIG. 6B is a simplified diagram illustrating aspects of a mass notification and venue security system in an embodiment.

FIG. 7 is a simplified diagram illustrating aspects of a mass notification and venue security system in an embodiment.

FIG. 8 is a simplified diagram illustrating aspects of a mass notification and venue security system in an embodiment.

FIG. 9 is a simplified diagram illustrating aspects of a mass notification and venue security system in an embodiment.

FIG. 10 is a simplified diagram illustrating aspects of a mass notification and venue security system in an embodiment.

FIG. 11 is a simplified diagram illustrating aspects of a mass notification and venue security system in an embodiment.

FIG. 12 is a simplified diagram illustrating aspects of a mass notification and venue security system in an embodiment.

FIG. 13 is a simplified diagram illustrating aspects of a mass notification and venue security system in an embodiment.

FIG. 14 is a simplified block diagram illustrating a mass notification and venue security system in an exemplary embodiment.

FIG. 15 is a simplified block diagram illustrating a mass notification and venue security method in an exemplary embodiment.

### DETAILED DESCRIPTION OF ILLUSTRATIVE EMBODIMENTS

Reference now should be made to the drawings, in which the same reference numbers are used throughout the different figures to designate the same components.

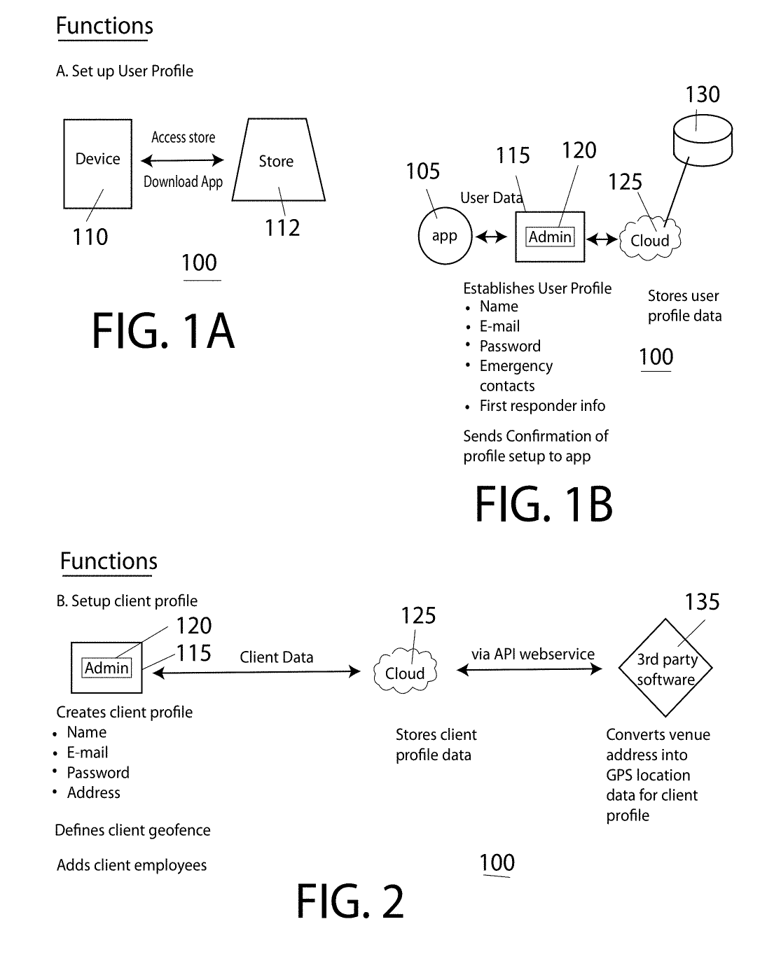

FIGS. 1A-13 illustrate aspects of an exemplary mass notification and venue security system 100. Disclosed subject matter provides systems and methods for venue security including mass notifications, including capability for immediate communications between all or many unfamiliar individuals in a venue, such as in a venue perimeter, by personal smartphones each having a downloadable smartphone software application installed thereupon and operable for communications with a venue security system, a mass notification system, a venue security system having mass notification functionality, a mass notification system having venue security system functionality, or any combination of the preceding systems, and other personal smartphones in the same defined venue perimeter and having the same or a compatible smartphone software application or other identified smartphone communications functionality such as, for example, text messaging capability. Disclosed subject matter provides such systems and methods for venue security including mass notifications provided from a cloud-based server resource and accessible via such a smartphone software application and/or portal, such as, for example, a local or remote system portal accessible by a browser or on a local software application by security system administrators and related professional security system personnel registered to use the system in various roles and with various access authorizations and restrictions. Disclosed subject matter provides such systems and methods for venue security including mass notifications, and configured for communications with a large number of identical or compatible downloadable software applications installed on personal smartphones of casual visitors, without requiring pre-registration by the individuals. It will be understood that such systems and methods provide and include an expanded venue security network including a large number of temporary security information resources for collecting information input or collected by individuals distributed about the venue in their personal use of the venue, and for sending and receiving alerts and mass notifications, which are provided by the large number of personal smartphones each having the identical or compatible downloaded software application and individuals using the same, where the personal smartphones are temporarily in communication with the venue security system and mass notification system only while each individual is present at the venue. It will be understood that having such an expanded venue security network enables increased information sources and information collection, and increased dissemination of communications among many individuals for security in the venue, which may improve detection, identification and tracking of security threats and medical emergencies, and improves speed of the responses of professional venue security personnel to such emergency events, with reduced risk, threat and harm to individuals and security personnel without incurring the high cost of expanding installation of permanent, fixed infrastructure that might provide similar capability and functions, and which is rendered unnecessary.

FIGS. 1A and 1B illustrate aspects of a mass notification and venue security system 100 in an embodiment. System 100 may include a software application 105 installed and residing on a personal wireless device 110 such as, for example, a smartphone or smart watch. The software application 105 may be accessed and subsequently downloaded onto the user's personal wireless device 110 from a downloads platform 112, such as the Apple Store or the Google Play Store. Once the application 105 is downloaded, a system server 115 may provide a link from the application 105 to an administration portal 120 on system server 115. The administration portal 120 may be provided to personal wireless device 110 from system server 115. The administration portal 120 may issue prompts requesting user information and, after user information is entered on personal wireless device 110, the administration portal 120 may send a verification text with a passcode to user wireless device 110. The personal wireless device 110 may receive the passcode when entered by the user and may provide same to system server 115. Upon providing the passcode, the personal wireless device 110 is subsequently allowed access to the system server 115. User profile data is requested by the administration portal 120 issuing prompts for such information to the user at the display of the personal wireless device 110 and upon receiving same, may pass the user profile data to the system server 115. The system server 115 may pass the user profile data to cloud-based storage 130 (see FIG. 12) accessible via a communication network or network cloud 125, which may include the Internet.

FIG. 2 illustrates aspects of a mass notification and venue security system 100 as shown generally in FIG. 1. System 100 may include including personal wireless device or personal mobile device 110 (“personal mobile device”). The venue client profile, including venue client employees (i.e. Security Monitors, Security Officers), may be completed in the administration portal 120 of server 115. The venue client profile includes the geofence location(s) and size(s) and possible beacons' locations and descriptions. In an embodiment, the administration portal may push the information to the network cloud 125 and via an API webservice to a 3^{rd} party geolocation software application 135, wherein the geofence location(s) and size(s) may be converted into GPS and IPS location data for the venue client profile.

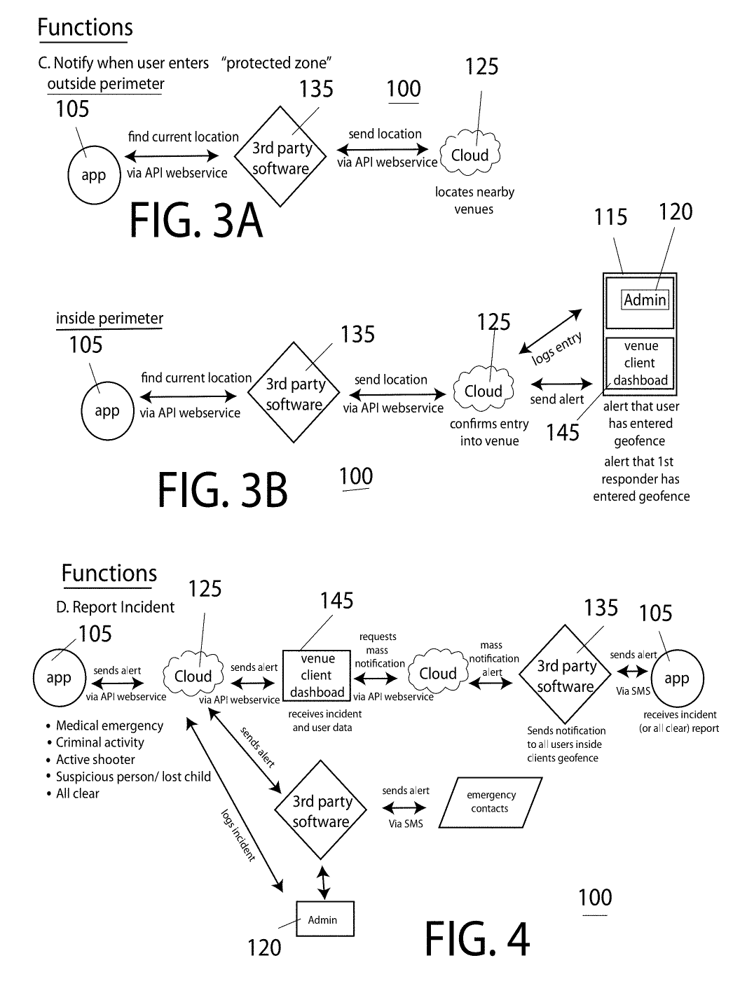

FIGS. 3A and 3B illustrate an exemplary flowchart of an embodiment of system 100 responding to entry of a new personal mobile device 110 into the target zone or protected zone 140 of a venue location. When a personal mobile device 110 having the software application 105 installed thereupon is located outside a protected zone 140 (a geofence) the user of application 105 can locate nearby geofence on the application 105 on his personal mobile device 110. When a personal mobile device 110 with the application enters a protected zone 140 (a geofence), the 3^{rd} party geolocation software application 135 sends an alert to the user's personal mobile device 110. The 3rd party geolocation software logs entry in the administration portal and alerts the venue client dashboard 145 that the specific user associated with the personal mobile device has entered the protected zone indicated by the geofence at the venue location. The venue client dashboard 145 may be provided on system server 115.

FIG. 4 illustrates an exemplary flowchart of system 100 in an embodiment, for an incident event. When a user of the software application 105 reports an incident, an alert is sent from the application 105 installed on the user's personal mobile device 110, through the cloud via API webservice to the venue client dashboard 145, the administration portal 120, and the 3^{rd} party geolocation software 135. The venue client dashboard 145 can subsequently send an individual notification or mass notification to the application 105 on personal wireless devices 110 of all users in the specific geofence or to all users in all of the client's geofences through 3^{rd} party software 135 via SMS. The 3^{rd} Party Software 135 will send SMS alerts to the application user's emergency contacts.

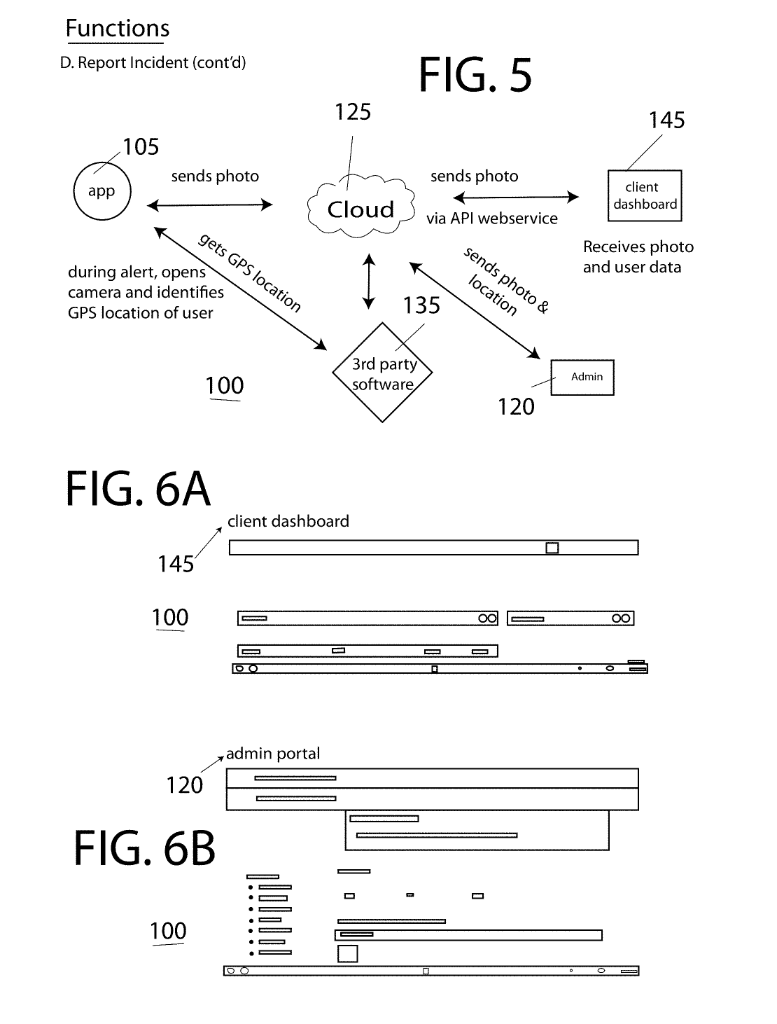

FIG. 5 illustrates a further exemplary flowchart of system 100 in an embodiment, for an incident event. When the application 105 user reports an incident by making entries using application 105 on the user's personal wireless device 110, the user application 105 can use the camera of the personal wireless device 110 and upload and send a photo within the application 105 to the system server 115, that will provide the geofence and send the information to the administration portal 129 and the venue client dashboard 145 via 3^{rd} party software 135.

FIG. 6A illustrates for system 100 an exemplary screenshot of a venue client dashboard 145 including a map that shows the geofences and locations of potential incidents that have been submitted.

FIG. 6B illustrates an exemplary screenshot of an administration portal 120 that provides an overview of various analytics as well as a navigation panel that provides access to many underlying functions, client profiles, geofences, user profiles, a history of incidents and messages.

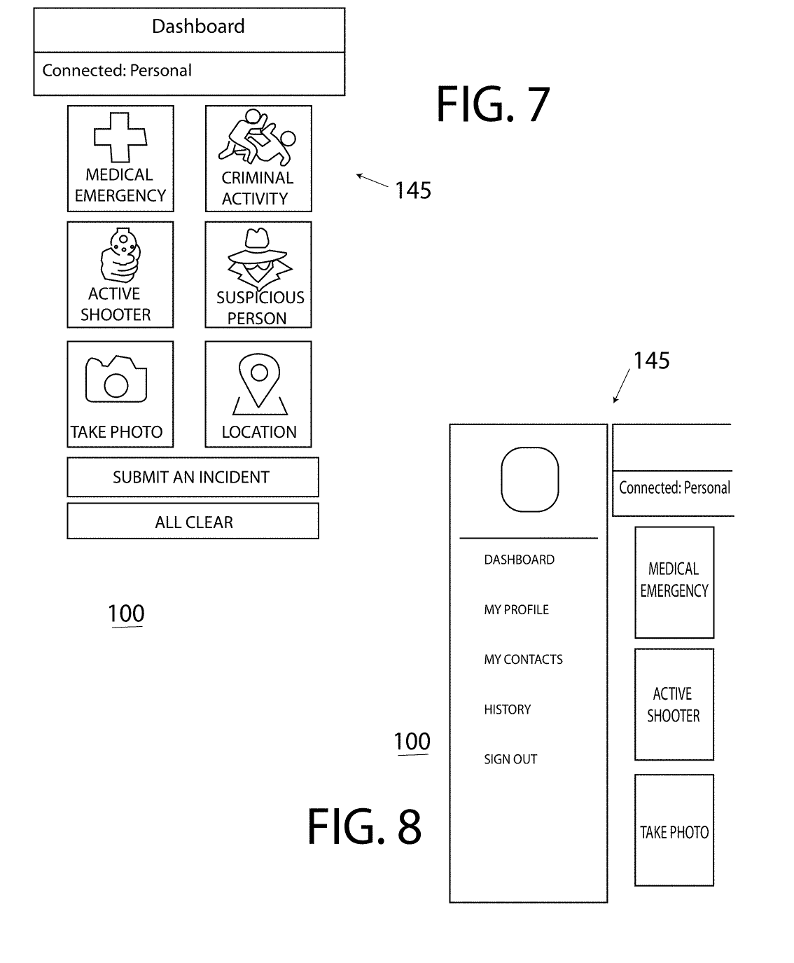

FIG. 7 illustrates an exemplary screenshot of system 100 including a mobile dashboard of the end-user application 105. Mobile dashboard may include predesigned incident buttons and a “submit an incident” button that allows the app user to send a customized incident. When pressing the Location button nearby geofence(s) are shown.

FIG. 8 illustrates a further exemplary screenshot for system 100 including the end-user application 105 having the mobile dashboard shown generally in FIG. 7. When pressing the horizontal bars, the navigation panel can appear to provide access for the user of the application to set up personal preferences and see the application user's profile and history.

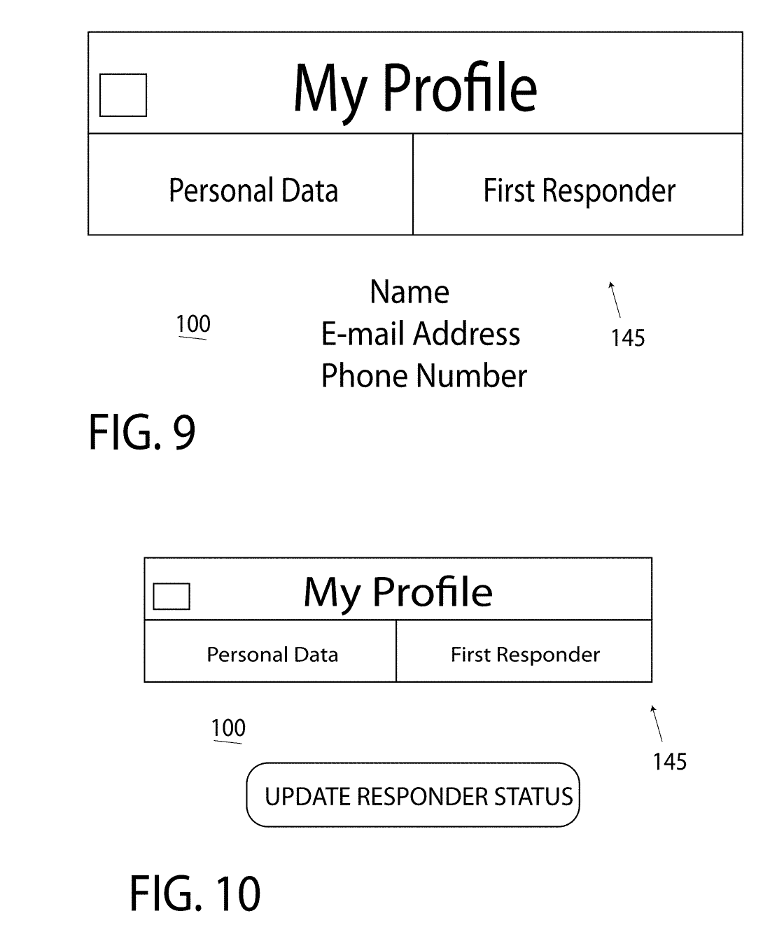

FIG. 9 illustrates a further exemplary screenshot of system 100 including application 105 having the mobile dashboard. In the configuration illustrated in FIG. 9, the user profile field within the application 105 includes two tabs, the first one for the role of end user, wherein personal data includes the end user's name, email address, and phone number.

FIG. 10 illustrates a further exemplary screenshot of system 100 including application 105 having the mobile dashboard. The user profile field within the application has two tabs, the second one for the role of first responder, that enables the user to self-identify and register as a registered first responder (such as Fire, Police, Paramedic roles) with their first responder license number.

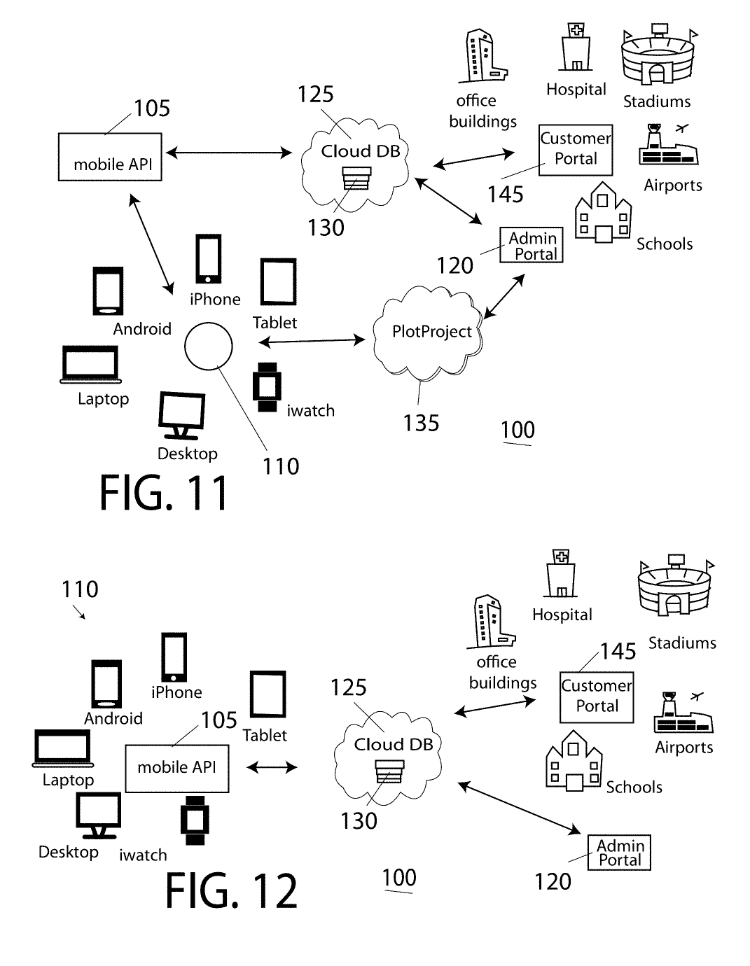

FIG. 11 illustrates aspects of the mass notification and venue security system 100 in an embodiment. Interaction modes and relationships of the plurality of end-user personal wireless devices 110 with the cloud network 125 and server 115 are illustrated. The application 105 installed on personal wireless device 110 interact in communication relationships with venue customer portal 145 and administration portal 120 via application 105, cloud database 130, and 3^{rd} Party geolocation software 135 such as, for example, PlotProject (Plot Project, Amsterdam, Netherlands).

FIG. 12 illustrates aspects of a mass notification and venue security system 100 in an embodiment. This illustration shows that for system 100 all personal wireless devices 110 may interact via the mobile software application programming interface (API) with the venue customer portal 145 and the administration portal 120 may be stored in the cloud database 130 accessible via cloud network 125.

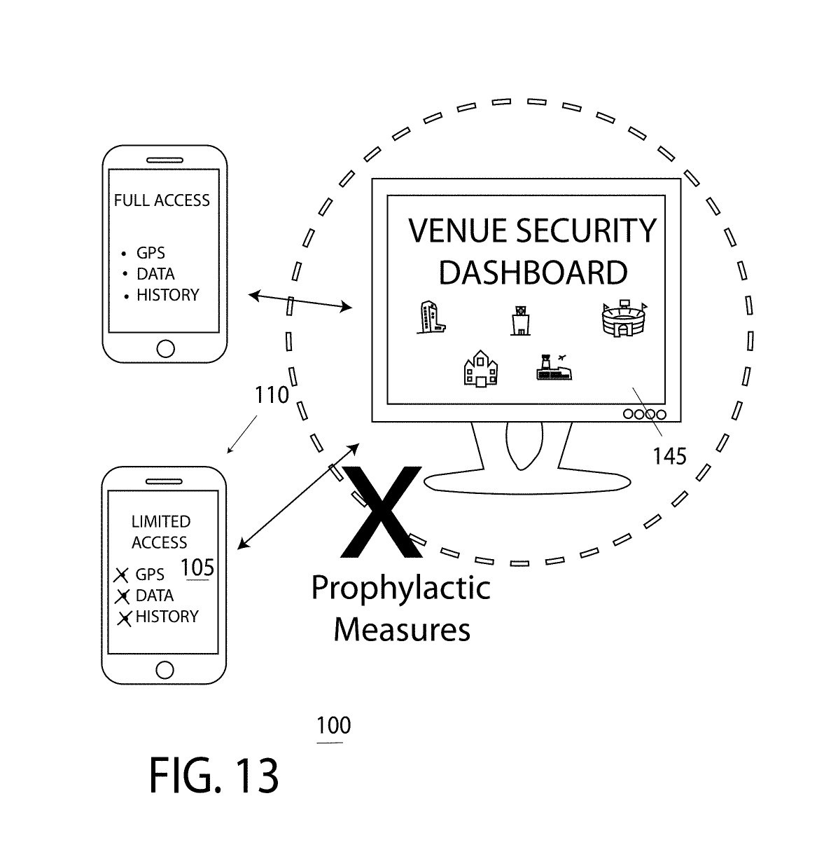

FIG. 13 illustrates aspects of a mass notification and venue security system 100 in an embodiment. The user of application 105 installed on personal wireless device 110 may have conditional open access to the system 110 and may appear on the venue client dashboard 145 only when certain criteria are met such as, for example, the end-user submitting an incident report while within a specific geofence or entering a geofence at a physical venue.

Referring to FIGS. 3A-4 such a system may include the providing of information that may include, but is not limited to the following to a mass notification and venue security system server, which may be a cloud server resource, having suitable processor and memory resources, having a suitable network interface to enable communications over a communications network, and which is supports, enables and executes an administration software application of the mass notification and venue security system. Such an administration software application, for example, may include executable code resources to: receive, store, output, send and/or process information or data; and execute operations, methods, steps and/or modules using information or data. An administrative software application may, for example, manage permissions and communications for smartphones including, but not limited to: name, phone, device token, date and time, networking connection and GPS coordinates. It will be understood that a token may be associated with a particular smartphone and/or downloaded smartphone application for managing, issuing, revoking, representing and storing permissions information, identification information, and communications information.

Referring again to FIGS. 1A-13, embodiments of the present disclosure may transmit security mass notification alerts across multiple platforms, including cellular network to personal mobile devices, e.g. smartphones (e.g. Androids, iPhones and other cellular technologies), which may be located within a geo-fenced designated area. In some embodiments, alerts may be sent during potential, perceived or imminent danger.

Existing technology is limited in that it typically, when available, requires that a user, or user's mobile device, be associated with a specific software application for a limited community. The present disclosure improves on existing technology by allowing a single sign on event for users, which can then interact with security networks whenever available.

In some embodiments, a notification may be transmitted to a software application on a personal mobile device to provide notification that the user is within a protected perimeter and that they are now connected to security. The software application user is automatically added to the open mass notification and venue security system client dashboard when they enter the secured perimeter allowing for interaction. By the software application on each personal mobile device, individuals may use the mass notification and security system to send and receive messages to and from the venue security system and venue security personnel while in a designated protected area or perimeter corresponding to or designated as the venue. Capability of the software application to enable direct interaction by the individual enables immediate and detailed communications with venue security personnel and the venue security system during an emergency.

In the designated perimeter of a protected zone associated with the mass notification and venue security system, personal mobile devices including the software application enable and perform functions of a handheld mobile security device for each individual having such a personal mobile device including the software application, and further may provide security services and information for members of the public in immediate proximity of such individuals using and participating in providing the expanded network system. The software application, the smartphone and the software application users all become an extension of security adding additional eyes and ears to venue safety.

Software application users are able to send “emergency alerts” that are preprogrammed messages to security as well as original incident reports while in the designated area, and therefore are able to get immediate assistance. The software application cuts down on the time needed to contact security.

When an emergency alert is sent, it is received by the venue's mass notification and venue security system client dashboard. The dashboard displays the information and enables the venue security administrator or other personnel using the dashboard to be informed of the emergency and take actions according to the venue's security protocols.

When an emergency alert is sent, it is logged into the administration portal. The portal enables the mass notification and venue security system administrator to keep track of reported emergencies from all supported venues. The alert logs may provide backup data for the venue's client dashboard and can be used for further investigation.

The software application user has the capability within the software application to send photos to security to support any alerts or incident reports. This enables, for example, venue security to use the information during event response, follow up or investigation.

Disclosed subject matter includes systems and methods that identify and solve problems previously unrecognized or unknown to those of skill in the art and solve problems including the providing of timely and specific information for improving safety, well-being and security of individuals, including regular visitors, transient visitors, and casual visitors, moving in and out of large public spaces that may be defined as one or more protected zones each having a respective perimeter, such that individuals may be connected in communication with venue security systems having mass notification functionality, and security personnel via the same, at all times when entering, and throughout, each such defined venue.

A plurality of the mass notification and venue security systems may provide or form a network of protected venues that are connected by the software applications associated with personal mobile devices of individuals.

The mass notification and venue security system software application can be used by an individual having the personal mobile device in any venue having an identical or compatible protected zone mass notification and venue security system. Each venue may separately maintain and operate their individual closed, preexisting security systems. The overall network of all protected zone mass notification and venue security systems for a plurality of venues may thus create and provide multiple locations where all individuals having the protected zone software application installed on a personal mobile device.

The protected zone mass notification and venue security system thus creates an environment of locations of venues where individuals may utilize the protected zone downloaded software application to actively participate in providing security information for each venue and protect themselves and others.

When an alert is sent to venue security, multiple designated contacts designated by each individual using the protected zone software application user will receive an SMS alert. These alerts will enable the contacts to be informed of the emergency.

The software application allows users to indicate whether they are first responders or have other designated skills for providing medical care, emergency logistics management, security, response capabilities and communications.

A system that combines cloud-based localized mass notification security software with personal security functionality. The software is uniquely designed to interface with the mobile software application installed on all Android, iPhone, and other similar cellular phone technologies. The software application is an interactive software application that has preprogrammed alerts and the capability to send original incident reports via SMS to venue security and include a supporting picture. This allows the software application user by virtue of having and using the software application to become a viable extension of a venue security network and the smartphone to become a handheld security device. Security can send mass notification alerts to all software application users in its designated area for security and safety matters. The system, for example, may use GPS and Wi-Fi functionality to inform venue security of the location of the software application user when emergency alerts and incident reports are received. GPS functionality is used to define the designated perimeters for venues and allow software application users to be informed about the location of protected venues or areas. Communication can be initiated from either the software application user or venue.

All smartphones having identical or compatible downloadable software applications installed thereupon can function in all venues where any communications infrastructure, such as a local WIFI, LAN, WAN, cellular, or other mobile communications network can provide a communications link, whether direct or indirectly routed across suitable communications infrastructure or communications resources in any manner, with a compatible protected zone server resource, such as a cloud-based server, or with other smartphones having the identical or compatible downloadable software applications installed thereupon. Such a networked plurality of smartphone applications and server resources may provide a communications network infrastructure for communication across all locations and venues where any protected zone system is operable, and thus may provide a globally interconnected safety network for individuals, venues and professional security and safety personnel having the downloaded software application on smartphones in their possession or having access to a protected zone system portal such as from a browser. Individuals having the software application on their personal smartphone, when not in a designated protected zone perimeter, also can utilized basic personal security functions of the software application such as, for example, sending pre-programmed SMS text messages to multiple designated contacts or recipients in relation to potential or imminent danger, or to request assistance in a personal emergency, along with information regarding the location and related information about the personal smartphone and individual user.

One of ordinary skill will understand that, although exemplary systems and methods are described herein as using GPS and Wi-Fi communications, such systems and methods may use any suitable wireless communications protocol, such as Bluetooth, and may enable use of any suitable location determination techniques, such as triangulation techniques and signal analysis location techniques, to provide communications or location information for a venue security system or venue security personnel to be informed of the location, or to determine the location, of the application user's smartphone and the user when communications, such as emergency alerts and incident reports, are sent by use of the application user's smartphone and received by the venue security system, or when communications are received by the application user's smartphone from the venue security system, or when communications are provided to, or received from, other visitors having the application accessible on their smartphones or similar personal wireless devices.

It will be understood that, in embodiments, the application may enable rapid, low error, simplified completion and sending of preformatted communications from a user's smartphone to a venue security system or venue security personnel, such as preformatted “emergency alerts” or incident reports, that are preprogrammed messages to a venue security system or venue security personnel, and thus may obtain or call for immediate assistance quicker and more reliably than where a user otherwise would require additional time to create a new communication without preformatting and preprogramming. The application providing preformatted, preprogrammed messages thus may reduce input steps, time and information that is required for the user to obtain immediate or timely assistance from venue security personnel responsive to the user's communication to the venue security system, and may improve the likelihood of user in a time sensitive crisis situation in the venue, such as an immobile user having an injury, receiving immediate or timely assistance of the appropriate types. The application thus may reduce time needed for the user to contact venue security personnel, and may allow immediate, timely connection and communication to, or from, venue security personnel even where the application user has no prior knowledge of, and no access to, contact information for venue security personnel. An emergency alert communication from a user, being received by the venue security system, may be routed to the venue's application dashboard, and thus may enable the venue security personnel to gain immediate, timely information about the emergency, such as where in the venue it has occurred or is occurring, and may enable venue security personnel to take action based upon the information, according to the venue's security protocols.

One of ordinary skill will understand that, although exemplary systems and methods are described herein as using GPS functionality for determining and defining the locations of designated venue perimeters, and allowing application users to be informed about the location of designated perimeters of protected venues or areas, such systems and methods may also utilize other mapping or locating information including, for example, longitude and latitude information, to define or identify designated perimeters for venues. Such systems and methods thus may enable application users to receive information about the locations of designated perimeters of protected venues or areas.

One of ordinary skill will understand that in embodiments, disclosed systems and methods may include the venue security client or management dashboard having the functionality or capability of contacting visitors to a venue, including random visitors who are not part of a fixed, established community, when the visitors have departed the protected designated perimeter of the venue. Such a period may include, for example, an extended period such as, for example, up to 72 hours, from the time when the user's smartphone having the application entered or left a protected venue perimeter. In embodiments, such a system may enable such contacting of visitors during an extended period following an event, even where the application user did not press or initiate an incident button, incident notification or communication with the venue security system or venture security personnel. Such functionality may enable the venue security system, venue security personnel, public safety officials and law enforcement officials to follow-up with such individuals, via automated communications and non-automated communications, to obtain or provide information regarding the visitor for an extended period following a visit to the venue or incident at the venue.

One of ordinary skill will understand that a venue security client dashboard may have the capability to maintain a log or record of all visitors having a smartphone or other personal wireless device in the geofenced perimeter. In embodiments, such a log or record may be maintained for an extended period following an event at the venue or following a visit to the venue, such as, for example, a period of 72 hours, to enable use of the application and usage of the users' smartphone information, to provide follow-up contacts with individuals or to enable follow-up activation of a mass notification message to former visitors to the venue's geofenced location. It will be understood that such capability for follow-up contact with individuals or follow-up mass notification messages, for example, may enable venue security personnel or law enforcement personnel in performing investigation activities, requesting assistance in identifying suspected criminals or terrorists from individuals who were seated or present in a particular section of the venue, or to notify and provide assistance for individuals who may have suffered exposure to a communicable illness or a toxic agent from contact or proximity to a suspected carrier present in the venue. In one embodiment, for example, the client dashboard may be capable of providing identification information, such as smartphone information and location or movements, of a large number of visitors to the venue during a two or three-hour duration period of a certain event. In embodiments, for example, an administrative dashboard and permanent storage may have capability to maintain a permanent log of all visitors to all geofenced perimeters of all venues in all locations, worldwide, that are served by the system, and may enable creation, maintaining and permanent storage of a log of all incidents submitted at any venue served by the system, permanently or, for example, a period of 7 years. In embodiments, such a system may have administrative capability to make such logs available to clients, law enforcement, or for research, where appropriate.

In embodiments, for example, where a fixed, permanent venue does not exist at a location, or an existing permanent venue configuration is changed to require different geofenced perimeters for an event, such as an impromptu event like a street festival or unusually large event that spills over to outside spaces, a system may include a temporary venue geofence perimeter established for a location. Such a temporary venue geofence perimeter may include temporary internal geofence coordinates within an existing permanent geofence perimeter of an existing venue; temporary external geofence coordinates near an existing permanent geofence perimeter of an existing venue; both of the preceding; or, may be established where no permanent venue exists. An application user within the newly created geofence perimeter may automatically be incorporated into the system, such as via the administrative dashboard. In embodiments, for example, GPS information for the smartphone provided to the administrative dashboard may provide indication to the administrative dashboard and venue security system where the user smartphone is located within the venue geofence perimeter including, or specifically within, the venue temporary venue geofence perimeter.

In embodiments of systems and methods as disclosed, a user smartphone or other personal wireless device may include the application having an emergency beacon transmitter. In embodiments, a system may include a rescuer wireless device having an emergency beacon receiver, such as a wireless tablet having emergency beacon receiver software, for detecting emergency beacon transmissions from the emergency beacon transmitter of each functioning smartphone or personal wireless device having the application with an emergency beacon transmitter. In embodiments, such a rescuer wireless device having emergency beacon receiver software may receive transmissions from a user's smartphone having an emergency beacon transmitter, for locating the user's smartphone, even when the user's smartphone is buried under rubble. Such rubble may include, for example, thick debris and crushed concrete. In embodiments, such system may include a data processing system configured for identifying one or more signals originating from the user's smartphone having an application including emergency beacon transmission functions. In embodiments, such a system may use GPS, Wi-Fi, emergency Wi-Fi hotspots, and other wireless tracking and locating technology within the designated venue perimeter. In embodiments, such a system may include a security system dashboard application configured to detect or receive wireless communications signals and detect or receive data transmitted from the user's smartphone in such wireless communication signals and generated by the application having emergency beacon transmitter functionality, including faint signals. Such a system may include providing the dashboard application with a history of the user's smartphone usage and locations within the designated perimeter, and such history may extend from creation of the geofence venue perimeter or entry of the user's smartphone into the venue, through the last location that may be identified or determined for the user's smartphone within the venue. Such location determining may include references to the venue floor plan, which may be stored in the system or may be accessible by the system.

In embodiments of systems and methods as disclosed, a user smartphone or other personal wireless device may include the application having an emergency beacon transmitter. In embodiments, a system may include a rescuer wireless device having an emergency beacon receiver, such as a wireless tablet having emergency beacon receiver software, for detecting emergency beacon transmissions from the emergency beacon transmitter of each functioning smartphone or personal wireless device having the application with an emergency beacon transmitter. In embodiments, such a rescuer wireless device having emergency beacon receiver software may receive transmissions from a user's smartphone having an emergency beacon transmitter, for locating the user's smartphone, even when the user's smartphone is submerged in water. Such embodiments may include, for example, a user smartphone or personal wireless device manufactured or conditioned for resistance to water, or which is waterproof under specified conditions, and it will be understood that such waterproof qualities of a wireless device may be certified by the manufacturer. In embodiments, such system may include a data processing system configured for identifying one or more signals originating from the user's smartphone having an application including emergency beacon transmission functions. In embodiments, such a system may use GPS, Wi-Fi, emergency Wi-Fi-hotspots, and other wireless tracking and locating technology within the designated venue perimeter. In embodiments, such a system may include a security system dashboard application configured to detect or receive wireless communications signals and detect or receive data transmitted from the user's smartphone in such wireless communication signals and generated by the application having emergency beacon transmitter functionality, including faint signals. Such a system may include providing the dashboard application with a history of the user's smartphone usage and locations within the designated perimeter, and such history may extend from creation of the geofence venue perimeter or entry of the user's smartphone into the venue, through the last location that may be identified or determined for the user's smartphone within the venue. Such location determining may include references to the venue floor plan, which may be stored in the system or may be accessible by the system.

A system that combines cloud-based localized mass notification security software with personal security functionality. The software is uniquely designed to interface with the mobile application installed on all Android, iPhone, and other similar cellular phone technologies. The application is an interactive app that has pre-programmed alerts and the capability to send original incident reports via SMS to venue security. This allows the app user by virtue of having and using the app to become a viable extension of a venue security network. The app user simultaneously sends alerts to pre-defined emergency contacts. In addition, venue security can send mass notification alerts to all app users in its designated area for security and safety matters. Communication can be initiated from either the app user or venue. Furthermore, the app when not in a designated area will act as a personal security app in which personal security alerts are sent via SMS to designated contacts about potential danger. The system uses GPS, WIFI and Bluetooth functionality to inform venue security of the location of the app user when emergency alerts and incident reports are received. GPS functionality is used to define the designated perimeters for venues and allow app users to be informed about the location of protected venues or areas.

Current mass notification systems require that an app user be part of a pre-established community (e.g. employees of the company, students/faculty of a university, etc.) to receive notifications in the case of an emergency. In addition, personal security apps do not have the capability to double as a mass notification receiver. This leaves customers, guests and other casual visitors out of the communication flow with venue security when emergencies occur. By connecting everyone within the venue perimeter who downloads the app to their phone, expands the security network of the venue to provide more “eyes and ears” able to detect security threats and medical emergencies, which speeds the response of venue security personnel. Saving time saves lives.

Software is designed to send out security mass notification alerts to all smartphones (e.g. androids, iphones and other cellular technologies) in a geofenced designated area during potential, perceived or imminent danger. This is a better solution than what is currently on the market because most systems require that a user be a part of a specific pre-approved community. Whereas with app users, any smartphone user can become part of the venue security network.

Apps receive a “welcome to” notification to let them know when they have entered a protected perimeter and that they are now connected to security. The app user is automatically added to the client (security) dashboard when they enter the secured perimeter allowing for interaction as needed.

App users can send and receive messages to and from venue security while in the designated perimeter. The interactive feature of the app allows for immediate and more detailed communication with venue security during an emergency.

In the designated perimeter, smartphones with the app become handheld security devices for the public.

The app, the smartphone and the app users all become an extension of security adding additional eyes and ears to venue safety.

App users can send “emergency alerts” that are preprogrammed messages to security as well as original incident reports while in the designated area, and therefore are able to get immediate assistance. The app cuts down on the time needed to contact security and allows immediate connection to security without the app user having prior knowledge of or access to security contact information.

When an emergency alert is sent, it is received by the venue's client dashboard, allowing the venue's security to know about the emergency, where it occurred, and act according to the venue's security protocol.

When an emergency alert is sent, it is logged into the admin portal, which allows the administrator to keep track of reported emergencies from all of its venues, which could be used as backup data for the venue's client dashboard and can be used for further investigation.

The app user has the capability within the app to send photos to security to support any alerts or incident reports. This will allow venue security to use this information during follow up or an investigation.

This software solution solves the problem of people moving in and out of large public spaces but still being connected at all times with security.

The system creates a network of protected venues that are connected by the app user. The app can be used in any protected venue while the venues still maintain their individual security system. This network creates multiple protected locations for the app user.

The software system creates an environment where app users are empowered to be a part of security and to protect themselves and others using their enabled smartphone.

When an alert is sent to venue security, (3) designated contacts of the app user will receive an SMS alert. This will allow them to be informed of the emergency.

The app allows users to indicate whether they are first responders, which may allow venues to leverage this on-site assistance during an emergency.

The client dashboard has the capability to keep a log of all visitors to its geofenced in perimeter for up to 72 hours, and is able to during an emergency to activate a mass notification message to those former visitors to its geofenced location to help security and law enforcement with any investigation they may be conducting regarding the emergency. The client dashboard is able to identify visitors that have visited the venue in two hour increments.

The company administrative dashboard has the capability to keep a log of all visitors to all geofences and a log of all incidents submitted for up to 7 years, and has the ability to make those logs available to its clients or law enforcement when appropriate.

The software downloaded on a mobile tablet is able to create an on-the-spot geo-fence perimeter internal or external where there is not an existing Geofence, and any app user within the newly created geofence will automatically be incorporated into the main dashboard. The GPS technology in the smartphone will alert the Dashboard where the smartphone is within its perimeter.

The software installed on a mobile tablet can detect functioning smartphones, tablets, smartwatches and other mobile technology that have a downloaded app even when those devices are buried under rubble, thick debris and some crushed concrete by using an advance data processing system that detects a certain signal put out by the smartphone, using GPS, Emergency WIFI-hotspot and other tracking technology within the perimeter. The software allows the security dashboard to detect the faint signals and data that the app is transmitting. The app will provide the dashboard with the history of the smartphone within the designated perimeter from the moment the geofence is created and will also provide the security dashboard with the last location of the smartphone within the venue utilizing the uploaded venue floor plan, if available

The software installed on a mobile tablet can detect Smartphones, tablets, smartwatches and other mobile technology submerged in water where certified by the manufacturer of the mobile device to be waterproof and within a designated internal or external perimeter. Using an advance data processing system that detects certain signals put out by a smartphone or other mobile technology like GPS, WIFI and/or other tracking technology within the perimeter. The software allows the security dashboard to detect the faint signals and data that the app on the Smartphone is transmitting.

A system that combines cloud-based localized mass notification security software with personal security functionality. The software is uniquely designed to interface with the mobile application installed on all Android, iPhone, and other similar cellular phone technologies. The application is an interactive app that has pre-programmed alerts and the capability to send original incident reports via SMS to venue security and include a supporting picture. This allows the app user by virtue of having and using the app to become a viable extension of a venue security network and the smartphone to become a handheld security device. Security can send mass notification alerts to all app users in its designated area for security and safety matters. The system uses GPS, WIFI, and Bluetooth functionality to inform venue security of the location of the app user when emergency alerts and incident reports are received. GPS functionality, with longitude and latitude, is used to define the designated perimeters for venues and allow app users to be informed about the location of protected venues or areas. Communication can be initiated from either the app user or venue. All apps can function in venues where there is technology (software), which creates an interconnected safety network for the app user. The app when not in a designated perimeter can act as a basic personal security app in that it can send a pre-programmed SMS to three designated contacts about potential or imminent danger and app user's location. The client dashboard has the capability of contacting random visitors (not part of a set community) once they have departed the protected perimeter for up to 72 hours even if that app user did not press an incident button, but merely entered the protected venue with a downloaded app.

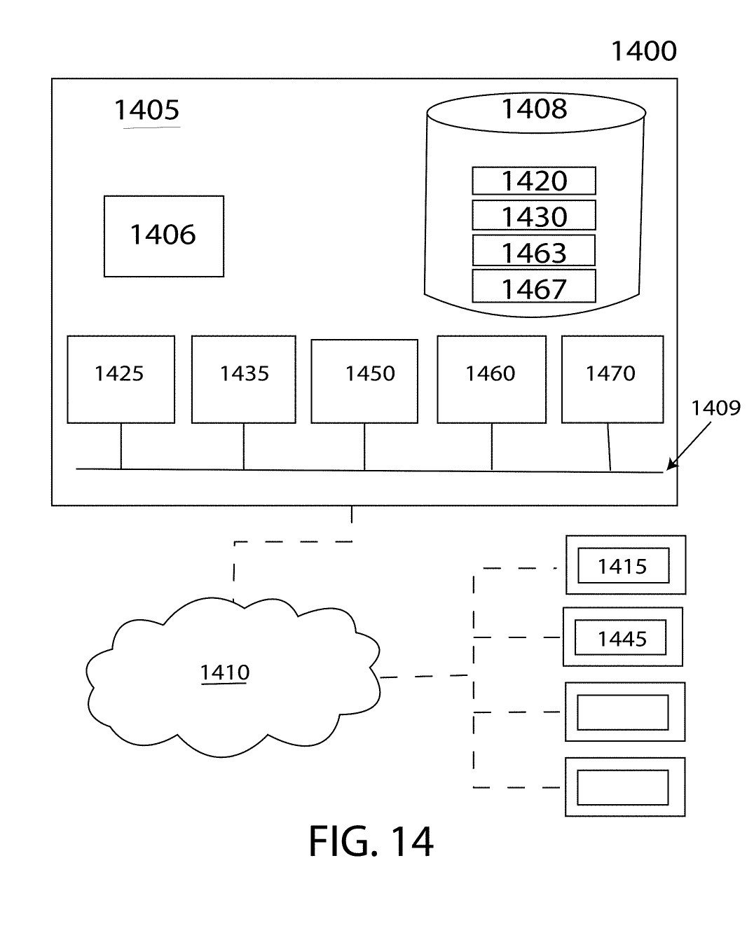

Illustrated in FIG. 14 is a system 1400 for mass notifications and venue security (“notification system”), in an exemplary embodiment. System 1400 may include a cloud-based mass notification and venue security system server 1405 configured over a communication network 1410. Server 1405 may include a processor 1406 operably coupled to memory 1408. Server 1405 may include a system bus 1409 and a plurality of modules configured to perform functions of server 1405. It will be understood that the modules may be embodied in application software, hardware, or both.

As shown in FIG. 14, system 1400 may include communications network 1410 operable for two-way communications from said server 1405 to each one of a plurality of personal wireless devices 1415. Each one of the personal wireless devices 1415 may be associated with an individual who may visit or attend an event at any one or more of a plurality of unique physical venues, as elsewhere described in this disclosure.

As shown in FIG. 14, system 1400 may include a venue perimeter identifier 1420 associated with a unique physical venue accessible to individuals, where an event occurs. It will be understood that a venue perimeter identifier 1420 may be accessible in a database of event perimeter identifiers for a plurality of unique physical venues where system 1400 is enabled for active usage by individuals visiting the same. Server 1405 may include a venue identification module 1425 performed by processor 1406 to compare a wireless device location signal communicated from each personal wireless device 1415 to a database of venue perimeter identifiers 1420 for multiple physical venues, to determine when a particular personal wireless device 1415 is located in a venue perimeter, such as a venue perimeter geofence. Venue identification module 1425 thus may compare a geolocation signal provided from such a personal wireless device 1415 with a database of venue perimeter identifiers 1420 including venue perimeter geofence locations. In embodiments, venue identification module 1425 may also be configured to further identify location of a personal wireless device 1415 in one of a plurality of protected zones of the physical venue. In embodiments, venue identification module 1425 may be configured to further identify location of each personal wireless device 1415 in zones within the physical venue, by comparing location of the personal wireless device 1415 to a venue zone identifier. Server 1405 may be configured to issue one of a plurality of user zone notifications to an individual in possession of the personal wireless device 1415, via an output of the personal wireless device 1415 when the device 1415 is identified as being located in a zone within the venue.

As shown in FIG. 14, system 1400 also may include an event status identifier 1430 associated with a time-bounded event at said unique physical venue. It will be understood that an event status identifier 1430 may be an event status identifier database record for a plurality of time-bounded events when system 1400 is enabled for active usage by individuals visiting the event at a venue, where the system 1400 is enabled for active usage for both the event and the venue, by individuals visiting the same. Such time-bounded events may include, for example, sporting events at stadium venues, concert events at music event venues of different sizes, festival events at corresponding festival venues, events such as classes at venues such as classrooms or auditoriums of schools, colleges or universities, and events such as business hours of a corporate campus or office venue.

Server 1405 may include a event identification module 1435 performed by processor 1406 to compare a wireless device location signal communicated from each personal wireless device 1415 to a database of event status identifiers 1430 for multiple time-bounded events, to determine when a particular personal wireless device 1415 is located in a physical venue identified by a venue perimeter identifier 1420 during a time period of a time-bounded event indicated by an event status indicator 1430 for the venue identified by the event perimeter identifier 1420. Event identification module 1435 thus may compare actual time provided for a particular personal wireless device 1415 with a database of time-bounded event status identifiers 1430 including event times for events occurring at the physical venue indicated by the venue perimeter identifier 1420.

As shown in FIG. 14, system 1400 may include a plurality of personal wireless devices 1415, such as, for example without limitation, smartphones or smart watches. System 1400 may include a protected zone software application 1445 installed on each personal wireless device 1415 and configured to be identified in relation to the server 1405 for communications with same via communications network 1410. Protected zone software application 1445 may be configured to issue to an individual a user notification via an output of the respective personal wireless device 1415 when identified by both of the following: location signal of the personal wireless device 1415 being at or inside a unique physical venue indicated by the venue perimeter identifier 1420 for the physical venue, and the preceding occurring during a time period within the time-bounds of an event occurring at the same physical venue, and associated with the time-bounded event by the event status identifier 1430.

As shown in FIG. 14, server 1405 and the protected zone software application 1445 installed on each personal wireless device 1415 may be configured to use the venue perimeter identifier 1420 and the event status identifier 1430 to provide one-way mass notification communications and two-way venue security communications between the server 1405 and each one of the plurality of personal wireless devices 1440.

As shown in FIG. 14, server 1405 may include a mass notification module 1450 configured to use the venue perimeter identifier 1420 and the event status identifier 1430 to provide one-way mass notification communications between the server 1405 and each one of the plurality of personal wireless devices 1440. Such mass notification communications may be enabled between the server 1405 and each one of the plurality of personal wireless devices 1440 by both of the following: location of same associated with said unique physical venue by said venue perimeter identifier, and time of same temporarily associated with said time-bounded event by said event status identifier.

As shown in FIG. 14, server 1405 may include a two-way security communications module 1460 configured to use the venue perimeter identifier 1420 and the event status identifier 1430 to provide two-way security communications between the server 1405 and each one of the plurality of personal wireless devices 1440. Such two-way security communications may be enabled between the server 1405 and each one of the plurality of personal wireless devices 1440 by both of the following: location of same associated with said unique physical venue by said venue perimeter identifier, and time of same temporarily associated with said time-bounded event by said event status identifier.

Referring to FIG. 14, server 1405 also may include a security administration module 1470 configured to provide security administration communications to the identified personal wireless devices 1440 identified as being located at the physical venue by the during time-bounds of an event occurring at the same venue. Security administration communications may originate from administration input from venue security personnel, administration input from a local venue security system of the physical venue, or from super-administration input from mass notification super-administration personnel responsible for relaying or issuing notifications to multiple venues, such as all venues in a city, state or country.

As shown in FIG. 14, server 1405 may include two-way communications module 1460 configured to manage a plurality of ad hoc two-way venue security communications between server 1405 and each of said plurality of personal wireless devices 1415 identified by an authorized security role identifier 1465 associated with at least one of the plurality of personal wireless devices 1415. Two-way communications module 1460 may be configured to manage a plurality of ad hoc two-way venue security communications between server 1405 and each of said plurality of personal wireless devices 1415 identified by a trusted visitor role identifier 1467 associated with at least one of the plurality of personal wireless devices 1415. In an embodiment, two-way communications module 1460 may be configured to manage a plurality of ad hoc patch-through two-way venue security communications between each of said plurality of personal wireless devices, at least one device being identified by an authorized security role identifier and at least one other device identified by a trusted visitor role.

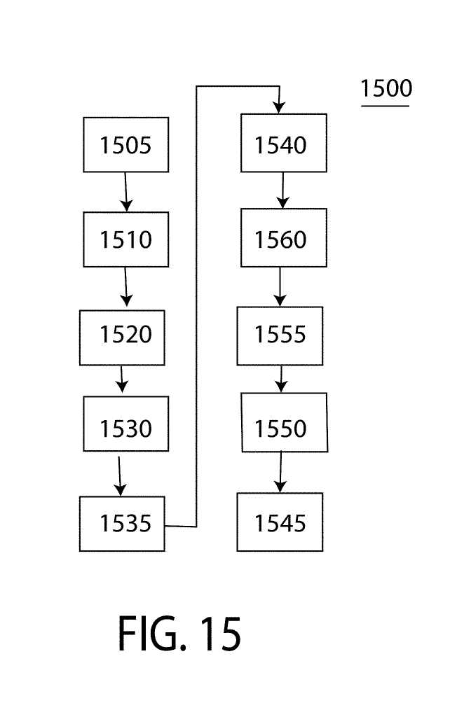

Illustrated in FIG. 15 is a method 1500 for mass notifications and venue security communications. In an embodiment, method 1500 may be performed by a processor accessing a non-transitory computer readable medium including executable instructions which, when executed in a processing system, causes the processing system to perform the steps of method 1500 as disclosed herein.

Method 1500 may include first accessing 1505 a cloud-based mass notification and venue security system server. Server 1405 described hereinabove and shown in FIG. 14 may be suitable. Method 1500 may include second accessing 1510 a communications network operable for two-way communications from the server to a plurality of personal wireless devices. Method 1500 also may include first providing 1515 a venue perimeter identifier associated with a unique physical venue accessible to individuals. Such a venue perimeter identifier 1515 may be accessed in a database. Method 1500 may include second providing 1520 an event status identifier associated with a time-bounded event at said unique physical venue. Such an event status identifier may be accessed in a database.

Method 1500 may include first enabling 1525 communications with a plurality of personal wireless devices, each having a protected zone software application installed thereupon. The personal wireless devices may be configured to be identified in relation to the server for communications with the server.

Method 1500 may include second enabling 1535 both one-way mass notification communications and two-way venue security communications between the server and each one of the plurality of personal wireless devices. Second enabling 1535 may include the server and the software application installed on each personal wireless device being configured to use the venue perimeter identifier and the event status identifier, to provide the one-way mass notification communications and two-way venue security communications between said server and each of said plurality of personal wireless devices identified by both of the following: device location at the physical venue associated with the venue perimeter identifier, and time of the device being located at the physical venue being within time bounds of an event occurring at the same venue and indicated by the event status identifier.

Method 1500 may include first issuing 1540 a user notification, by the installed software application on the user's respective personal wireless device, wherein the application is configured to issue the user notification via an output of the respective personal wireless device. First issuing 1540 may be performed when both of the following are identified: location of the device is associated with the unique physical venue by the venue perimeter identifier, and time of the device being at the venue is within time-bounds of an event identified by the event status identifier at the same venue.

Method 1500 may include third enabling 1545 zone communications in relation to a plurality of venue zone identifiers associated with protected zones of the unique physical venue. The installed software application may be configured to issue one of a plurality of user zone notifications via an output of the respective personal wireless device when identified by both of the following: being located in a zone associated with a venue zone identifier, and during a time period within time bounds associated with a time-bounded event identified by an event status identifier for the same venue.

Method 1500 may include fourth enabling 1550 security role communications. In fourth enabling 1550, the server may be configured to manage a plurality of ad hoc two-way venue security communications between the server and each one of the plurality of personal wireless devices, where such devices are identified by all of the following: being located at a particular venue indicated by a venue perimeter identifier, during a time period within time bounds of an event occurring at the same venue as indicated by an event status identifier, and the particular personal wireless device identified as used by an individual having an authorized venue security role identified by an authorized security role identifier associated with the personal wireless devices.

Method 1500 may include fifth enabling 1555 trusted visitor role communications. In fifth enabling 1555, the server may be configured to enable or perform trusted visitor communications, by the server being configured to manage a plurality of ad hoc two-way venue security communications between the server and each personal wireless device identified by all of the following: being located at a particular venue indicated by a venue perimeter identifier, during a time period within time bounds of an event occurring at the same venue as indicated by an event status identifier, and the particular personal wireless device identified as used by an individual having a trusted visitor role identified by a trusted visitor role identifier associated with the personal wireless device.

Method 1500 may include sixth enabling 1560 patch-through ad hoc two-way communications, where both an authorized security role identifier and a trusted visitor role identifier are determined for a time period within time bounds of an event at the same venue.

Apparatus, methods and systems according to embodiments of the disclosure are described. Although specific embodiments are illustrated and described herein, it will be appreciated by those of ordinary skill in the art that any arrangement which is calculated to achieve the same purposes can be substituted for the specific embodiments shown. This application is intended to cover any adaptations or variations of the embodiments and disclosure. For example, although described in terminology and terms common to the field of art, exemplary embodiments, systems, methods and apparatus described herein, one of ordinary skill in the art will appreciate that implementations can be made for other fields of art, systems, apparatus or methods that provide the required functions. The invention should therefore not be limited by the above described embodiment, method, and examples, but by all embodiments and methods within the scope and spirit of the invention. In particular, one of ordinary skill in the art will readily appreciate that the names of the methods and apparatus are not intended to limit embodiments or the disclosure. Furthermore, additional methods, steps, and apparatus can be added to the components, functions can be rearranged among the components, and new components to correspond to future enhancements and physical devices used in embodiments can be introduced without departing from the scope of embodiments and the disclosure. One of skill in the art will readily recognize that embodiments are applicable to future systems, future apparatus, future methods, and different materials. All methods described herein can be performed in a suitable order unless otherwise indicated herein or otherwise clearly contradicted by context. The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein. Terminology used in the present disclosure is intended to include all environments and alternate technologies that provide the same functionality described herein.

1. A system for mass notifications and venue security, said system comprising:
a cloud-based mass notification and venue security system server;
a communications network operable for two-way communications from said server to a plurality of personal wireless devices;
a venue perimeter identifier associated with a unique physical venue accessible to individuals;
an event status identifier associated with a time-bounded event at said unique physical venue;
a plurality of personal wireless devices, each having a protected zone software application configured to be identified in relation to the server for communications with same;
said server and said protected zone software application configured to use said venue perimeter identifier and said event status identified to provide one-way mass notification communications and two-way venue security communications between said server and each of said plurality of personal wireless devices identified by both of the following:
location of same associated with said unique physical venue by said venue perimeter identifier, and
time of same temporarily associated with said time-bounded event by said event status identifier.

2. A system according to claim 1, further comprising:
said protected zone software application configured to issue a user notification via an output of the respective personal wireless device when identified by both of the following:
location of same associated with said unique physical venue by said venue perimeter identifier, and
time of same temporarily associated with said time-bounded event by said event status identifier.

3. A system according to claim 1, further comprising:
a plurality of venue zone identifiers associated with protected zones of said physical venue, said protected zone software application configured to issue one of a plurality of user zone notifications via an output of the respective personal wireless device when identified by both of the following:
location of same associated with a zone by said venue zone identifier, and
time of same temporarily associated with said time-bounded event by said event status identifier.

4. A system according to claim 1, further comprising:
said server configured to manage a plurality of ad hoc two-way venue security communications between said server and each of said plurality of personal wireless devices identified by all of the following:
location of same associated with said unique physical venue by said venue perimeter identifier,
time of same temporarily associated with said time-bounded event by said event status identifier, and
an authorized security role identifier associated with at least one of said plurality of personal wireless devices.

5. A system according to claim 1, further comprising:
said server configured to manage a plurality of ad hoc two-way venue security communications between said server and each of said plurality of personal wireless devices identified by all of the following:
location of same associated with said unique physical venue by said venue perimeter identifier,
time of same temporarily associated with said time-bounded event by said event status identifier, and
a trusted visitor role identifier associated with at least one of said plurality of personal wireless devices.

6. A system according to claim 1, further comprising:
said server configured to manage a plurality of ad hoc patch-through two-way venue security communications between each of said plurality of personal wireless devices identified by all of the following:
location of same associated with said unique physical venue by said venue perimeter identifier,
time of same temporarily associated with said time-bounded event by said event status identifier, and
an authorized security role identifier associated with at least one of said plurality of personal wireless devices.
a trusted visitor role identifier associated with at least one of said plurality of personal wireless devices.

7. A method for mass notifications and venue security, said system comprising:
first accessing a cloud-based mass notification and venue security system server;
second accessing a communications network operable for two-way communications from said server to a plurality of personal wireless devices;
first providing a venue perimeter identifier associated with a unique physical venue accessible to individuals;
second providing an event status identifier associated with a time-bounded event at said unique physical venue;
first enabling a plurality of personal wireless devices, each having a protected zone software application configured to be identified in relation to the server for communications with same;
second enabling said server and said protected zone software application configured to use said venue perimeter identifier and said event status identifier, to provide one-way mass notification communications and two-way venue security communications between said server and each of said plurality of personal wireless devices identified by both of the following:
location of same associated with said unique physical venue by said venue perimeter identifier, and
time of same temporarily associated with said time-bounded event by said event status identifier.

8. A method according to claim 7, further comprising:
first issuing, by said protected zone software application configured to issue a user notification via an output of the respective personal wireless device, when identified by both of the following:
location of same associated with said unique physical venue by said venue perimeter identifier, and
time of same temporarily associated with said time-bounded event by said event status identifier.

9. A method according to claim 7, further comprising:
third enabling zone communications, by a plurality of venue zone identifiers associated with protected zones of said physical venue, said protected zone software application configured to issue one of a plurality of user zone notifications via an output of the respective personal wireless device when identified by both of the following:
location of same associated with a zone by said venue zone identifier, and
time of same temporarily associated with said time-bounded event by said event status identifier.

10. A method according to claim 7, further comprising:
fourth enabling security role communications, by said server configured to manage a plurality of ad hoc two-way venue security communications between said server and each of said plurality of personal wireless devices identified by all of the following:
location of same associated with said unique physical venue by said venue perimeter identifier,
time of same temporarily associated with said time-bounded event by said event status identifier, and
an authorized security role identifier associated with at least one of said plurality of personal wireless devices.

11. A method according to claim 7, further comprising:
fifth enabling trusted visitor communications, by said server configured to manage a plurality of ad hoc two-way venue security communications between said server and each of said plurality of personal wireless devices identified by all of the following:
location of same associated with said unique physical venue by said venue perimeter identifier,
time of same temporarily associated with said time-bounded event by said event status identifier, and
a trusted visitor role identifier associated with at least one of said plurality of personal wireless devices.

12. A method according to claim 7, further comprising:
sixth enabling patch-through ad hoc two-way communications, by said server configured to manage a plurality of ad hoc patch-through two-way venue security communications between each of said plurality of personal wireless devices identified by all of the following:
location of same associated with said unique physical venue by said venue perimeter identifier,
time of same temporarily associated with said time-bounded event by said event status identifier, and
an authorized security role identifier associated with at least one of said plurality of personal wireless devices.
a trusted visitor role identifier associated with at least one of said plurality of personal wireless devices.

13. A non-transitory computer readable medium including executable instructions which, when executed in a processing system, causes the processing system to perform the steps of a method according to claim 7.
